(19) United States
(12) Patent Application Publication
(10) Pub. No.: US 2019/0030948 A1
(43) Pub. Date: Jan. 31, 2019

(54) Auxiliary Fastening Device for Securing an Ornamental Cover to a Wheel Disk

(71) Applicant: Superior Crown Material Co., Ltd., Tainan City (TW)

(72) Inventor: Ming-Fang Wang, Tainan City (TW)

(21) Appl. No.: 15/663,922

(22) Filed: Jul. 31, 2017

(51) Int. Cl. B60B 7/08; B60B 7/06

(52) U.S. Cl. CPC B60B 7/08; B60B 7/065

(57) ABSTRACT

An auxiliary fastening device includes a plurality of auxiliary male fasteners and a plurality of auxiliary female fasteners connected with the auxiliary male fasteners. Each of the auxiliary male fasteners includes a male body having a first side provided with a securing face secured on the wheel disk and a second side provided with a locking piece. Each of the auxiliary female fasteners includes a female body having a first side provided with a securing face secured on the ornamental cover and a second side provided with a locking groove locked onto the locking piece of each of the auxiliary male fasteners to secure the ornamental cover to the wheel disk. Thus, the auxiliary fastening device provides an auxiliary locking function so that the ornamental cover is locked onto the wheel disk solidly and stably.

### BACKGROUND OF THE INVENTION

### 1. Field of the Invention

The present invention relates to a fastening device and, more particularly, to an auxiliary fastening device for securing an ornamental cover to a wheel disk of a car.

### 2. Description of the Related Art

An ornamental cover is attached to a wheel disk of a car. The ornamental cover has different colors, shapes or patterns to enhance the aesthetic quality of the wheel disk. In general, the ornamental cover is secured on the wheel disk by locking, screwing, sticking or the like. However, the ornamental cover is secured on the wheel disk by a single fixing structure, so that the ornamental cover is not positioned on the wheel disk solidly and stably. Thus, when the fixing structure is worn out during a long-term utilization, the ornamental cover becomes loosened and is easily detached from the wheel disk, thereby causing danger to the driver when driving the car, and thereby easily incurring a traffic accident.

### BRIEF SUMMARY OF THE INVENTION

In accordance with the present invention, there is provided an auxiliary fastening device comprising a plurality of auxiliary male fasteners mounted on a wheel disk, and a plurality of auxiliary female fasteners mounted on an ornamental cover and connected with the auxiliary male fasteners to secure the ornamental cover to the wheel disk. Each of the auxiliary male fasteners includes a male body having a first side provided with a securing face secured on an outer face of the wheel disk and a second side provided with a locking piece. Each of the auxiliary female fasteners includes a female body having a first side provided with a securing face secured on an inner face of the ornamental cover and a second side provided with a locking groove corresponding to and locked onto the locking piece of each of the auxiliary male fasteners.

According to the primary advantage of the present invention, when the ornamental cover is mounted on the wheel disk, the primary fastening members of the ornamental cover are locked onto the spokes of the wheel disk, and each of the auxiliary female fasteners of the ornamental cover is locked onto each of the auxiliary male fasteners of the wheel disk, so as to provide a double locking function to secure the ornamental cover to the wheel disk, so that the ornamental cover is locked onto the wheel disk solidly and stably, thereby preventing the ornamental cover from being detached from the wheel disk.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of an auxiliary fastening device for a wheel disk and an ornamental cover in accordance with the preferred embodiment of the present invention.

FIG. 2 is a locally enlarged view of FIG. 1.

FIG. 3 is a cross-sectional view of an auxiliary male fastener of the auxiliary fastening device in accordance with the preferred embodiment of the present invention.

FIG. 4 is a cross-sectional view of an auxiliary female fastener of the auxiliary fastening device in accordance with the preferred embodiment of the present invention.

FIG. 5 is a perspective assembly view of FIG. 1.

FIG. 6 is a cross-sectional view of FIG. 5.

FIG. 7 is a cross-sectional view of an auxiliary male fastener of the auxiliary fastening device in accordance with another preferred embodiment of the present invention.

### DETAILED DESCRIPTION OF THE INVENTION

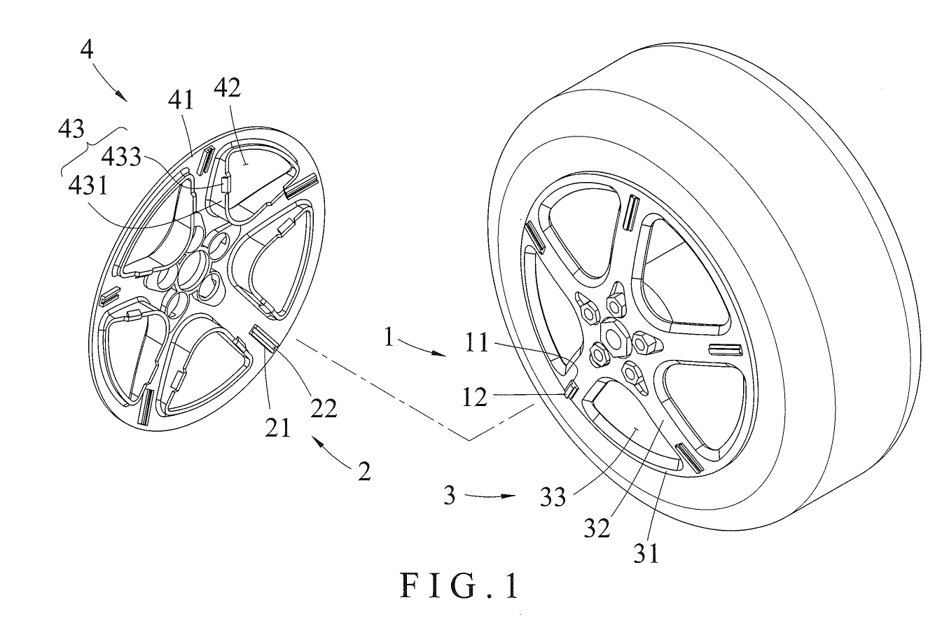

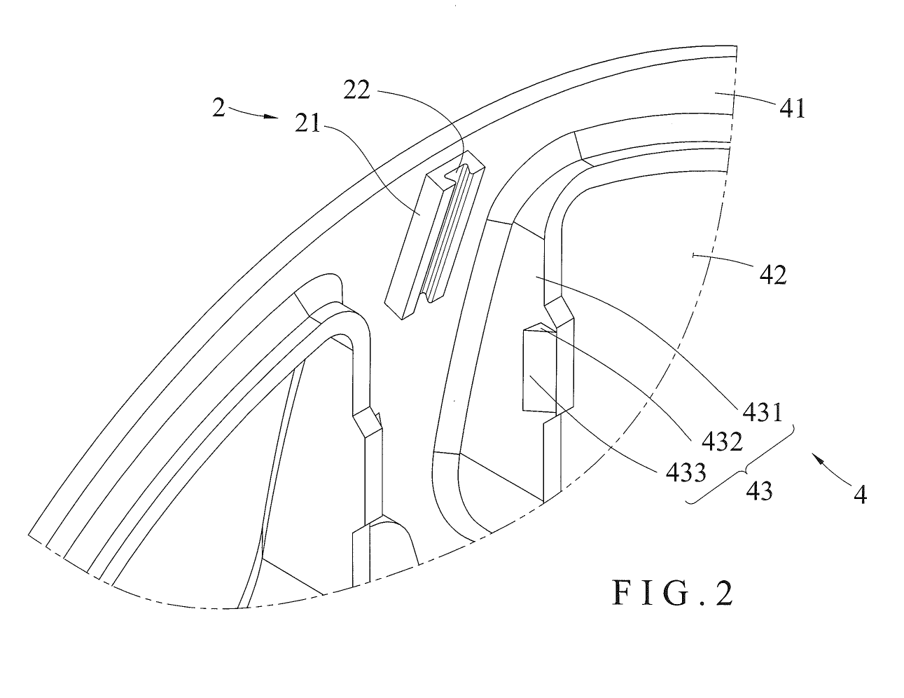

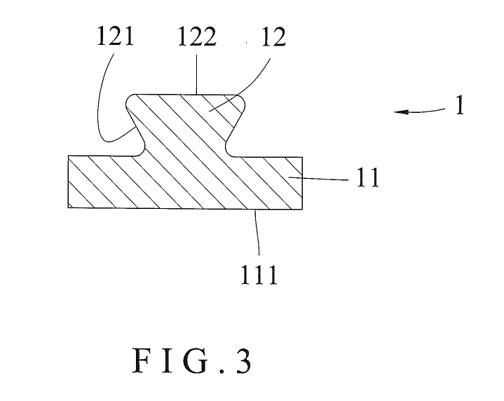

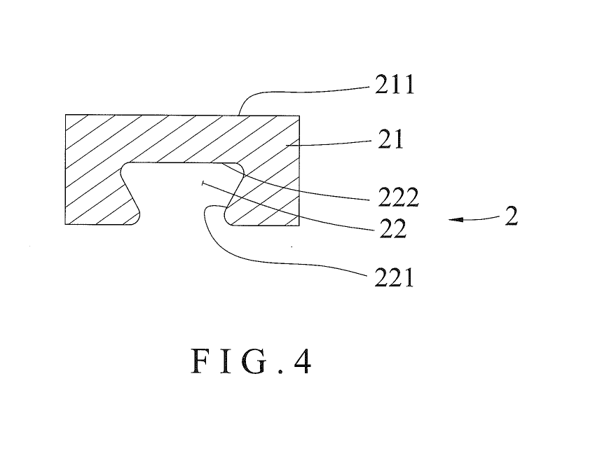

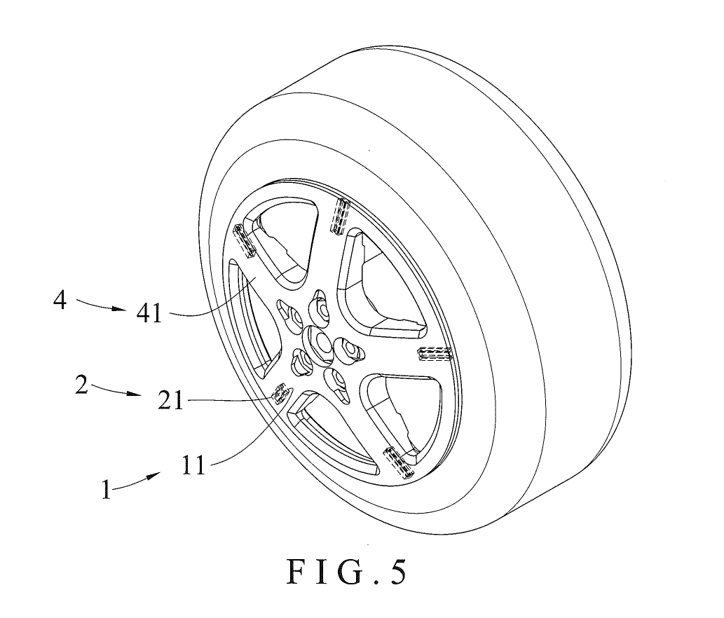

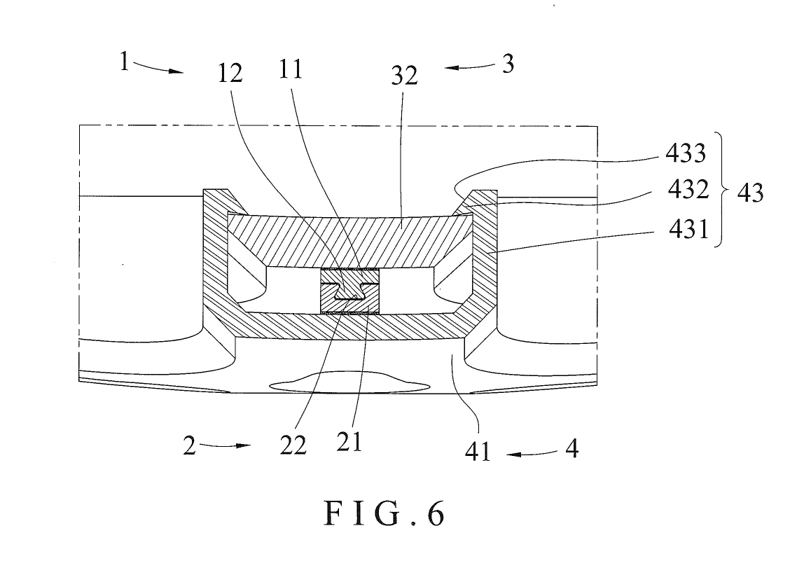

Referring to the drawings and initially to FIGS. 1-6, an auxiliary fastening device in accordance with the preferred embodiment of the present invention comprises a plurality of auxiliary male fasteners 1 mounted on a wheel disk 3, and a plurality of auxiliary female fasteners 2 mounted on an ornamental cover 4 and connected with the auxiliary male fasteners 1 to secure the ornamental cover 4 to the wheel disk 3.

The wheel disk 3 includes a ring 31, a plurality of spokes 32 connected with the ring 31, and a plurality of hollow holes 33 arranged between the spokes 32.

The ornamental cover 4 includes a cover body 41 formed with a plurality of openings 42, and a plurality of primary fastening members 43 mounted on the cover body 41 locked onto the wheel disk 3 to secure the ornamental cover 4 to the wheel disk 3.

Each of the primary fastening members 43 includes a projecting wall 431 protruding from a periphery of each of the openings 42 of the cover body 41 and inserted into each of the hollow holes 33 of the wheel disk 3, and two opposite locking blocks 432 each formed on an outer face of the projecting wall 431 and each locked onto one of the spokes 32 of the wheel disk 3. Each of the two locking blocks 432 has a ramp 433 to guide movement of each of the two locking blocks 432 on one of the spokes 32 of the wheel disk 3.

In assembly, when the ornamental cover 4 is mounted on the wheel disk 3, the projecting wall 431 of each of the primary fastening members 43 is inserted into each of the hollow holes 33 of the wheel disk 3, and each of the two locking blocks 432 of each of the primary fastening members 43 is locked onto one of the spokes 32 of the wheel disk 3. In such a manner, each of the spokes 32 of the wheel disk 3 is clamped between two adjacent projecting walls 431 and locked by two corresponding locking blocks 432. At this time, the ramp 433 slides on one of the spokes 32 during the assembly process to facilitate movement of each of the two locking blocks 432 on one of the spokes 32 of the wheel disk 3. Thus, the primary fastening members 43 of the ornamental cover 4 are locked onto the spokes 32 of the wheel disk 3 to secure the ornamental cover 4 to the wheel disk 3.

In the preferred embodiment of the present invention, each of the auxiliary male fasteners 1 includes a male body 11 having a first side provided with a securing face 111 secured on an outer face of the wheel disk 3 and a second side provided with a locking piece 12. Each of the auxiliary female fasteners 2 includes a female body 21 having a first side provided with a securing face 211 secured on an inner face of the ornamental cover 4 and a second side provided with a locking groove 22 corresponding to and locked onto the locking piece 12 of each of the auxiliary male fasteners 1. The locking groove 22 of each of the auxiliary female fasteners 2 and the locking piece 12 of each of the auxiliary male fasteners 1 have the same shape.

In assembly, when the ornamental cover 4 is mounted on the wheel disk 3, each of the auxiliary female fasteners 2 corresponds to each of the auxiliary male fasteners 1, and the locking groove 22 of each of the auxiliary female fasteners 2 is locked onto the locking piece 12 of each of the auxiliary male fasteners 1 to secure the ornamental cover 4 to the wheel disk 3. In such a manner, when the ornamental cover 4 is mounted on the wheel disk 3, the primary fastening members 43 of the ornamental cover 4 are locked onto the spokes 32 of the wheel disk 3, and each of the auxiliary female fasteners 2 of the ornamental cover 4 is locked onto each of the auxiliary male fasteners 1 of the wheel disk 3, to secure the ornamental cover 4 to the wheel disk 3 in a double locking manner, so that the ornamental cover 4 is secured on the wheel disk 3 solidly and stably.

In the preferred embodiment of the present invention, the male body 11 and the locking piece 12 of each of the auxiliary male fasteners 1 are formed integrally.

In the preferred embodiment of the present invention, the locking piece 12 of each of the auxiliary male fasteners 1 and the locking groove 22 of each of the auxiliary female fasteners 2 have the same trapezoid cross-sectional profile. The locking piece 12 of each of the auxiliary male fasteners 1 has two oblique faces 121 and a plane 122 located between the two oblique faces 121. Each of the two oblique faces 121 of the locking piece 12 and the first side of the male body 11 are arranged to have an acute angle with an arcuate corner. It is to be noted that, a larger angle and a smaller angle are defined between each of the two oblique faces 121 of the locking piece 12 and the first side of the male body 11, and the acute angle means the smaller angle between each of the two oblique faces 121 of the locking piece 12 and the first side of the male body 11. The plane 122 and each of the two oblique faces 121 of the locking piece 12 are arranged to have an acute angle with an arcuate corner. The locking groove 22 of each of the auxiliary female fasteners 2 has two oblique faces 221 and a plane 222 located between the two oblique faces 221. Each of the two oblique faces 221 of the locking groove 22 and the first side of the female body 21 are arranged to have an acute angle with an arcuate corner. The plane 222 and each of the two oblique faces 221 of the locking groove 22 are arranged to have an acute angle with an arcuate corner.

In the preferred embodiment of the present invention, the locking piece 12 of each of the auxiliary male fasteners 1 and the locking groove 22 of each of the auxiliary female fasteners 2 have the same isosceles trapezoid cross-sectional profile.

In the preferred embodiment of the present invention, the locking piece 12 of each of the auxiliary male fasteners 1 and the female body 21 of each of the auxiliary female fasteners 2 are made of flexible material. Preferably, the locking piece 12 of each of the auxiliary male fasteners 1 and the female body 21 of each of the auxiliary female fasteners 2 are made of plastic material. In such a manner, the locking groove 22 of each of the auxiliary female fasteners 2 is snapped and locked onto the locking piece 12 of each of the auxiliary male fasteners 1 easily and smoothly by provision of the elasticity and the arcuate corner of the locking groove 22 and the locking piece 12.

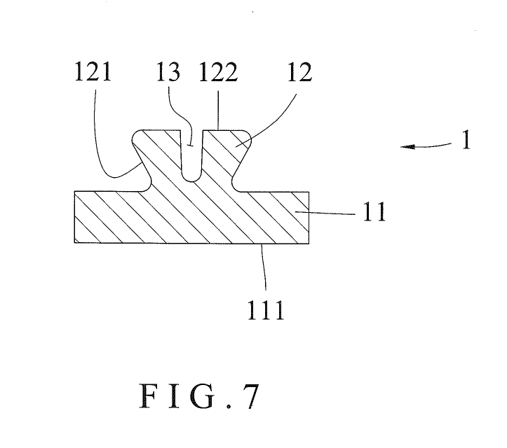

Referring to FIG. 7, the plane 122 of the locking piece 12 of each of the auxiliary male fasteners 1 is formed with a recess 13 to make the locking piece 12 of each of the auxiliary male fasteners 1 more flexible. In such a manner, when the locking groove 22 of each of the auxiliary female fasteners 2 is mounted on the locking piece 12 of each of the auxiliary male fasteners 1, the two oblique faces 121 of the locking piece 12 are compressed by the female body 21 of each of the auxiliary female fasteners 2 to contract toward the recess 13, so that the locking piece 12 of each of the auxiliary male fasteners 1 is contracted inward and inserted into the locking groove 22 of each of the auxiliary female fasteners 2 easily. After the locking piece 12 of each of the auxiliary male fasteners 1 is inserted into the locking groove 22 of each of the auxiliary female fasteners 2, the locking piece 12 of each of the auxiliary male fasteners 1 is expanded outward by its elasticity, so that the locking piece 12 of each of the auxiliary male fasteners 1 is locked in the locking groove 22 of each of the auxiliary female fasteners 2.

Accordingly, when the ornamental cover 4 is mounted on the wheel disk 3, the primary fastening members 43 of the ornamental cover 4 are locked onto the spokes 32 of the wheel disk 3, and each of the auxiliary female fasteners 2 of the ornamental cover 4 is locked onto each of the auxiliary male fasteners 1 of the wheel disk 3, so as to provide a double locking function to secure the ornamental cover 4 to the wheel disk 3, so that the ornamental cover 4 is locked onto the wheel disk 3 solidly and stably, thereby preventing the ornamental cover 4 from being detached from the wheel disk 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An auxiliary fastening device comprising:
a plurality of auxiliary male fasteners mounted on a wheel disk; and
a plurality of auxiliary female fasteners mounted on an ornamental cover and connected with the auxiliary male fasteners to secure the ornamental cover to the wheel disk;
wherein:
each of the auxiliary male fasteners includes a male body having a first side provided with a securing face secured on an outer face of the wheel disk and a second side provided with a locking piece; and
each of the auxiliary female fasteners includes a female body having a first side provided with a securing face secured on an inner face of the ornamental cover and a second side provided with a locking groove corresponding to and locked onto the locking piece of each of the auxiliary male fasteners.

2. The auxiliary fastening device of claim 1, wherein the male body and the locking piece of each of the auxiliary male fasteners are formed integrally.

3. The auxiliary fastening device of claim 1, wherein the locking groove of each of the auxiliary female fasteners and the locking piece of each of the auxiliary male fasteners have the same shape.

4. The auxiliary fastening device of claim 1, wherein:
the locking piece of each of the auxiliary male fasteners and the locking groove of each of the auxiliary female fasteners have the same trapezoid cross-sectional profile;
the locking piece of each of the auxiliary male fasteners has two oblique faces and a plane located between the two oblique faces;
each of the two oblique faces of the locking piece and the first side of the male body are arranged to have an acute angle with an arcuate corner;
the plane and each of the two oblique faces of the locking piece are arranged to have an acute angle with an arcuate corner;
the locking groove of each of the auxiliary female fasteners has two oblique faces and a plane located between the two oblique faces;
each of the two oblique faces of the locking groove and the first side of the female body are arranged to have an acute angle with an arcuate corner; and
the plane and each of the two oblique faces of the locking groove are arranged to have an acute angle with an arcuate corner.

5. The auxiliary fastening device of claim 4, wherein the locking piece of each of the auxiliary male fasteners and the locking groove of each of the auxiliary female fasteners have the same isosceles trapezoid cross-sectional profile.

6. The auxiliary fastening device of claim 4, wherein the plane of the locking piece of each of the auxiliary male fasteners is formed with a recess.

7. The auxiliary fastening device of claim 1, wherein the locking piece of each of the auxiliary male fasteners and the female body of each of the auxiliary female fasteners are made of flexible material.

8. The auxiliary fastening device of claim 7, wherein the locking piece of each of the auxiliary male fasteners and the female body of each of the auxiliary female fasteners are made of plastic material.
